(19) United States
(12) Patent Application Publication
(10) Pub. No.: US 2004/0222566 A1
(43) Pub. Date: Nov. 11, 2004

(54) Method for molding a product and a mold used therein

(76) Inventor: Hern Jin Park, Seoul (KR)

Correspondence Address: Finnegan Henderson Farabow, Garrett & Dunner, 1300 I Street NW, Washington, DC, 20005, US

(21) Appl. No.: 10/485,275

(22) PCT Filed: Jul. 29, 2002
(86) PCT No.: PCT/KR02/01435

(30) Foreign Application Priority Data
Jul. 31, 2001 (KR) 2001/46364

(51) Int. Cl. B29C 39/38

(52) U.S. Cl. 264/338; 425/3; 425/470

(57) ABSTRACT

The present invention relates to a method for molding a product and the molds used therein, wherein said method comprises the steps of heating a surface layer (16) of a mold cavity via induction heating to the temperature of 50-400 C for 0.5-20 sec, filling of molding material into the cavity and cooling the mold by circulating a cooling fluid through a cooling line, wherein the mold comprises a surface layer (16) and an insulating layer (17) in which micro-channels (15) or micro-holes (18) are constructed.

### TECHNICAL FIELD

The present invention relates to a method for molding a product and a mold used therein.

### BACKGROUND ART

Various methods have been used for molding products including a plastic product and they include an injection molding, a blow molding, a thermoforming and the like. The general procedure of molding a product comprises steps of casting a molding material such as thermoplastic materials, ceramics, and metals, which has been pre-heated to a temperature sufficient to be easily deformed, filled into a cavity of a mold, cooled down to a temperature sufficient for not being easily deformed and then taken out of the mold to be manufactured into a final product. This procedure, commonly known as a molding cycle, refers to a repetitive procedure and it often serves as a good index showing the productivity of a molding process. One of the most common ways to reduce the time required for the molding cycle is to keep the temperature of a mold lower thereby reducing the time required for cooling. Although this cold mold operation can reduce the cooling time, it also presents a few disadvantages. For example, this can make the surface quality of molded part worse. Sometimes, this can cause a residual stress in the molded part to be very large. In particular, this method is not appropriate in molding a product with a thin and long flow path and thus the resulting molded product often comes out in the form of an uncompleted product thus it becomes essential to design a molded product with a fair thickness. Still further, too rapid cooling of a molded product within the cold mold can prevent crystallization of the resulting product thus deteriorating the quality of the final products.

Alternatively, a method to increase the temperature of a mold can be used as a way to solve the above-mentioned problems. However, it is not also considered advantageous because the repetitive procedure of increasing and decreasing the temperature of a mold in this method can result in having a relatively long period of time for the molding cycle due to a large thermal mass thus reducing the productivity. Therefore, it is preferred to increase the temperature of the thin layer of the surface of a mold cavity with low thermal mass. And an insulation layer is provided between the surface layer and the main body of a mold.

However, these methods can also introduce many problems such as a separation of the thin surface layer from an insulation layer when there is a great temperature difference between heating and cooling steps; a difficulty in obtaining a uniform temperature on the surface of a mold cavity during the course of heating and cooling and much limitation in controlling the temperature to a desired level; a difficulty in greatly reducing an entire molding cycle because the insulation layer prevents the molded part from cooling.

For example, U.S. Pat. No. 5,234,637 discloses a method which uses an electric heating and a cooling by means of internal channels in a mold comprising a surface layer made of 0.01-0.1 mm thick copper and heated by electric current and an insulation layer. This method is advantageous in that it can provide an active heating. However, the thin heating layer of this method raises problems such as overheating or burning because the difficulty in obtaining a uniformly coated thickness of the surface layer often leads to uneven flow of electric current, and the surface layer may be detached from the insulation layer when they are heated at a high temperature.

U.S. Pat. No. 5,064,597 discloses an electric heating method and a method of forming a multi-layered mold comprising a heating layer and an insulation layer. Besides non-uniform heating, the cooling rate is not so fast due to the insulation structure. And this method also presents the problem of detachment of the two layers during heating and cooling steps thus being unable to impart uniform temperature increase.

U.S. Pat. No. 5,041,247 discloses a method of cooling using a cooling pipe in the main body of a mold comprising a multi-layered structure of a heating layer consisting of carbon steel and stainless steel and an insulation layer consisting of porous metal and plastic. However, this method can also raise the problem of detachment of layers when there is a great difference in temperature between heating and cooling. Further, this method requires a relatively long period of time for cooling because cooling is conducted on the main body of a mold.

Consequently, desirable methods are to obtain uniform and high temperature of the surface of a mold cavity as well as a short molding cycle by combining effectively the methods of heating and cooling. However, the above-mentioned methods are not considered advantageous because they do not provide so sufficiently fast cycle time and they have difficulty in acquiring uniform temperature-increase of a heating layer and, furthermore because they do not sufficient durability. Thus it is desirable to develop a new method which can reduce the period of time for a molding cycle and give uniform field of temperature as well as good durability.

### SUMMARY OF THE INVENTION

Accordingly, the object of the present invention is to provide a method to achieve a rapid and uniform heating and cooling of mold cavity surface, therefore, achieve both an improved molding-productivity and a molded part with improved quality, and a mold used therein which can resolve the above-mentioned problems of the conventional methods and the molds. More specifically, the present invention relates to a mold which comprises a integrated shell that is constructed by both a surface layer of the mold cavity with low thermal mass and an insulation layer which is located on the surface of the reverse side of the surface layer and comprises micro-channels or micro-holes. This integrated shell has good durability. And the present invention also relates to a method which comprises a rapid and uniform heating of the surface of mold cavity via induction heating and a rapid cooling by circulating a cooling fluid through a cooling line installed in mold base and or through micro-channels constructed in the insulation layer thereby achieving effective heating and cooling and the mold used therein.

The present invention can also employ other methods in order to increase the temperature of the surface of mold cavity such as circulating a fluid at high temperature through a cooling line or micro-channels or allowing an object at high temperature to make a contact with the surface of mold cavity during heating step.

### BRIEF DESCRITION OF THE DRAWINGS

FIG. 1 shows a cross-sectional view of the overall structure of a mold according to the present invention.

FIG. 2 shows a cross-sectional view of a preferred embodiment of a shell in a mold according to the present invention.

FIG. 3 shows a perspective view of the cavity in one side of a mold according to the present invention.

FIGS. 4a-4c show various preferred embodiments of cross-sections of A-A line in FIG. 2.

FIG. 5 shows s a cross-sectional view of another preferred embodiment of a shell in a mold according to the present invention.

FIG. 6 shows a cross-sectional view of a preferred embodiment of a connecting structure between a cooling pipe and micro-channels and a cross-sectional view of D-D line of a mold according to the present invention.

FIG. 7 shows a schematic view of induction heating in a molding method according to the present invention.

FIG. 8 is a perspective view which depicts an overall structure of a preferred embodiment of a mold and heating and cooling apparatus according to the present invention.

FIG. 9 shows a schematic cross-sectional view and an enlarged view of a preferred embodiment of a mold according to the present invention.

FIG. 10 shows a perspective view of a preferred embodiment of a shell in a mold according to the present invention.

FIGS. 11a and 11b respectively shows a graph which reflects the result of an example for the change of temperature on the surface of mold cavity according to time passage in the course of heating and cooling according to the present invention.

FIGS. 12a and 12b respectively shows a graph which reflects the result of another example for the change of temperature of the surface of mold cavity according to time passage in the course of heating and cooling according to the present invention.

FIG. 13 shows a schematic perspective view of a preferred embodiment of a mold according to the present invention applied in molding of a container.

FIG. 14 shows a perspective view of a preferred embodiment of induction heating coil used in a method of molding according to the present invention.

FIG. 15 shows a cross-sectional view of B-B line in FIG. 13.

FIG. 16a-16c shows various preferred embodiments of cross-sections of A-A line in FIG. 2.

[Code Explanation of Major Parts in Figs.]

[Code Explanation of Major Parts in FIGS.]

| | |
|---|---|
| 1. left half of a mold | 2. right half of a mold |
| 3, 4: main body of a mold | 5. cavity |
| 6. parting surface | 7, 8 shell |
| 9, 10: shell receiver | 11, 12: cavity surface |
| 13: a connecting part between a shell and the | |
| main body of a mold | |
| 14, 20: a cooling pipe | 15: micro-channels |
| 16: a surface layer | 17: an insulation layer |
| 18: micro-holes | |
| 19: a shell of low magnetic resonance material | |
| 21: cooling fluid line | 22. compressed air line |
| 23: induction heating coil | |
| 24: neck region of a bottle in the mold | |
| 25: bottom region of a bottle in the mold | |

### DISCLOSURE OF THE INVENTION

The present invention is described in detail as set forth hereunder.

The present invention relates to a method for molding a product which comprises steps of heating of surface layer of mold cavity, filling of a molding material into a mold, and cooling,

wherein the mold comprises a cavity, an integrated shell comprising a surface layer and an insulation layer in which micro-channels or micro-holes are constructed, and a main body of said mold;

the surface layer of said mold cavity is passively or aggressively heated via induction heating to the temperature of 50-400° C. for 0.5-20 sec; and

the surface layer of said mold cavity is cooled down within 0.1-20 sec after casting a molding material to said mold by circulating a cooling fluid through a cooling line in the main body of said mold and or circulating a cooling fluid through the micro-channels of said insulation layer on the surface of the reverse side underneath said surface layer.

The present invention is also characterized in that a part of said shell can be substituted with a low magnetic resonance material when there is a need to avoid temperature increase in a particular part of the surface of a mold cavity.

The present invention is further characterized in that a cooling fluid is continuously circulated through the cooling line installed in the main body of a mold during both said heating and said cooling period.

The present invention is still further characterized in that it can provide a method of active cooling; i.e., besides circulating a cooling fluid through a cooling line in main body, a cooling fluid can be circulated through said micro-channels during said cooling step.

The present invention is also characterized in that the heating is conducted after completely stopping the circulation of a cooling fluid through the micro-channels in the insulation layer and removing said cooling fluid from the micro-channels by means of compressed air or vacuum, and the circulation of a cooling fluid is conducted in due course during the step of cooling thereafter.

The present invention is described in more detail with reference to the following description taken in conjunction with the accompanying drawing figures wherein like numerals represent like elements throughout the figures.

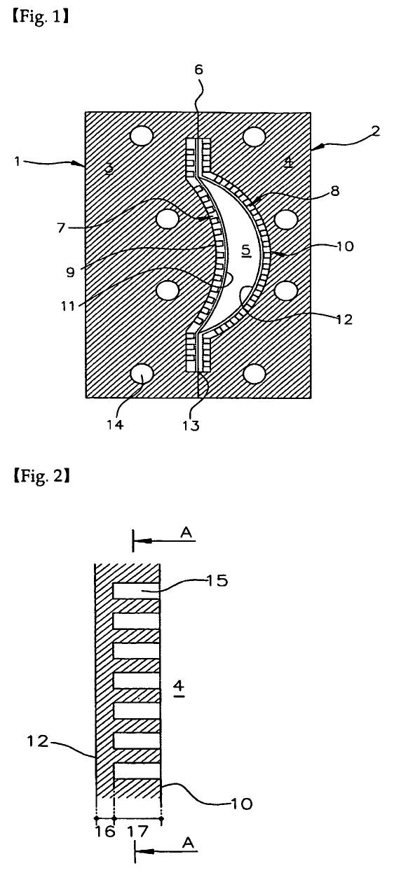

Referring to FIG. 1, the mold for molding a product according to the present invention comprises a cavity 5 which both left half 1 and right half 2 of said mold comprise, integrated shells 7 and 8 of which cross-sectional view is shown in FIG. 2, comprising

a surface layer 16 with a predetermined thickness which serves as the surface 11 or 12 of said cavity 5; and

an insulation layer 17 comprising micro-channels 15 or micro-holes 18 arrayed on the surface of the reverse side underneath said surface layer 16; and a main body 3 or 4 of said mold where said insulation layer is contacted.

In FIGS., 3 and 4, 7 and 8, 9 and 10, and 11 and 12 are respectively present on both left half 1 and right half 2 of the mold and thus only one of them will be described hereinafter.

The above shell 8 consists of a magnetic-resonance material capable of induction heating when induction heating is used as a heating method.

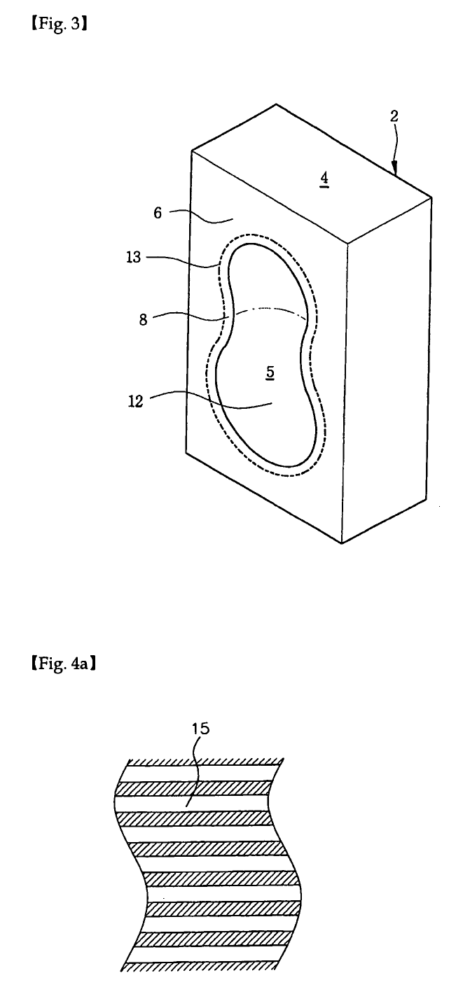

Referring to FIG. 3, the mold for molding a product according to claim 6, wherein said shell 8, is coalesced only in a border line 13 on a parting surface which is formed between left half and right half of said mold. And the reverse side of said shell and the shell 8 receiving part 10 can be also adhered over the whole interface.

Further, the above shell 8 is 1-25 mm thick and said surface layer 16 is 0.3-10.0 mm thick. Here, if the thickness of the surface layer is less than 0.3 mm, it results in difficulty in machining, deterioration in strength of structure and prevention of uniform temperature while it becomes less effective if it exceeds 10.0 mm.

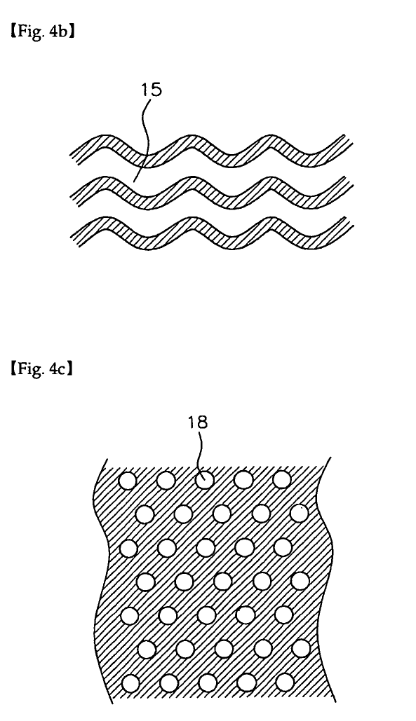

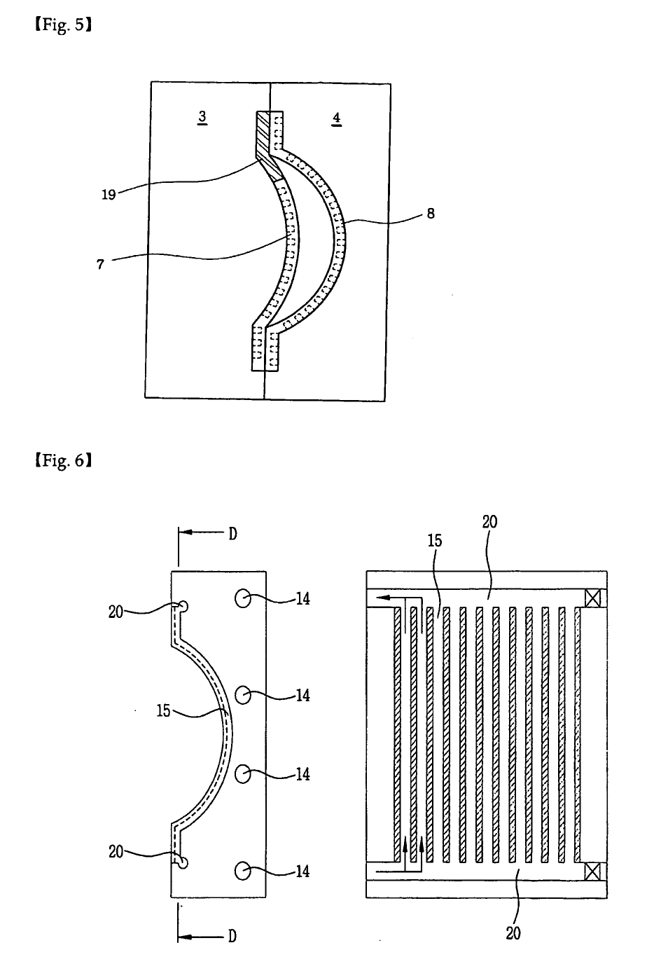

Referring to FIGS. 4a-4c, the insulation layer consists of micro-channels 15 or micro-holes 18 and the area portion of the empty space by micro-channels or micro-holes in the insulation layer is 20-90% of the layer. Here, if the area of the empty space is less than 20%, it results in lack of insulation, while it results in deterioration of strength of structure of shell 8 due to molding pressure or it results in excessive insulation if it exceeds 90%. Further, the micro-channels are formed on the surface of the reverse side of the insulation layer in a linear or a wave pattern and the micro-channels are made to be 0.3-10.0 mm wide. Here, if the width of the micro-channels are less than 0.3 mm, it results in difficulty in machining as well as circulation of a cooling fluid at the time of an active cooling while it becomes hard to maintain uniform temperature if it exceeds 10.0 mm.

The size of each micro-hole 18 is 0.3-10.0 mm in diameter. Here, if the thickness of the micro-hole is less than 0.3 mm, it results in difficulty in drilling while it becomes hard to maintain uniform temperature if it exceeds 10.0 mm.

Referring to FIG. 5, a part of said shell 7 comprising a surface layer and an insulation layer can be substituted with a low magnetic resonance material 19 when there is a need to avoid temperature increase in a part of the surface of the cavity of said mold.

Referring to in FIG. 6, a cooling fluid is continuously circulated through the cooling line 14 installed in the main body of the mold in the course of heating and cooling. In case when cooling is conducted by circulating a cooling fluid through micro-channels 15 in the insulation layer, an additional cooling line 20 is installed in the main body 4 of a mold apart from the existing cooling line 14 as a way to circulate a circulating agent through the micro-channels in the insulation layer and this is again directly connected to the micro-channels for the circulation of the cooling fluid during cooling period.

A preferred embodiment of the present invention is described in more detail by means of an induction heating method as set forth hereunder.

One way to increase the temperature of the surface of a mold cavity in the course of molding a product is, as shown in FIG. 7, to employ a method of induction heating which enables to provide uniform temperature distribution on the entire surface of mold cavity even when the molded product has a curved surface.

The induction heating method is performed in the order of inserting induction heating coil 23 into a mold when it is open, increasing temperature of the surface layer by induction heating, taking out the induction heating coil out of the mold and closing the mold. This method is very effective in rapidly and uniformly increasing the temperature of only the surface of mold cavity to a desired level because the heating layer is relatively thin and an insulation layer is located on the reverse side of the heating layer. A method of directly connecting electric current into the heating layer can be also used. However, this method has a few disadvantages that electrodes should be tightly attached on the surface of mold cavity and it is difficult to design a mold so that constant electric current is flowed through the curved surface of mold cavity for the uniform increase of temperature. In contrast, the induction heating method generates an induced current on the surface of mold cavity with a arbitrary curve and is a method to uniformly and rapidly increase temperature. In general, induction heating induces great increase in temperature on the surface close to a heater because the amount of electric current induced is inversely proportional to the square of a distance. However, the temperature increase above-mentioned cannot be easily achieved if an insulation layer is not provided due to heat transfer toward mold base. In contrast, the present invention comprises a surface layer 16 of low thermal mass which has an insulation layer 17 on its reverse side and thus can increase the temperature of a more specified layer.

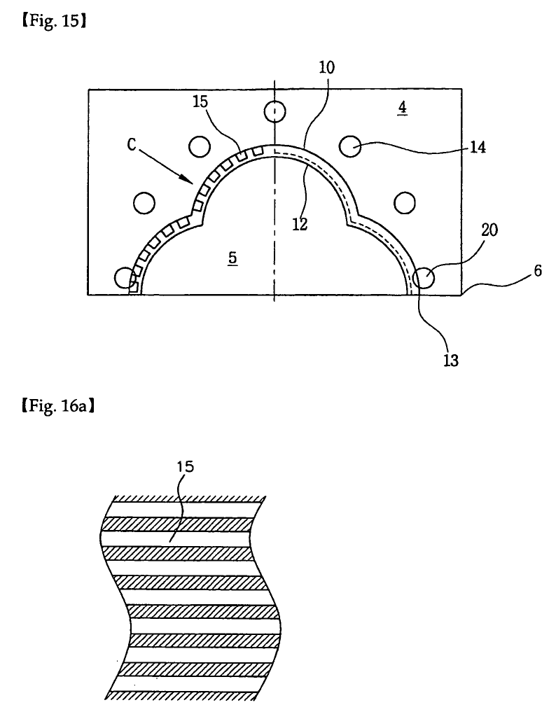

The induction heater used in the present invention is a heating coil type which is used in high frequency heating and thus the shape or the size of the heater can be changed according to the type of mold cavity. For example, in case of an injection molding, induction coil 23 manufactured in the form of mold cavity as shown in FIG. 7 can be used, whereas in case of a blow molding, the one with a cylindrical type as shown in FIG. 15 can be used.

In the course of heating mold cavity, lack of insulation will deter the temperature increase and also control of temperature and thermal energy becomes difficult. If insulation is provided during the process of heating, energy can be stored in the surface layer to be used in molding a product, however, too much insulation can also deter cooling process and thus the thickness of an insulation layer needs to be adjusted properly.

When circulating a cooling fluid through micro-channels as a way to actively perform a cooling process, the thickness of the wall of micro-channels can be very thin as long as it does not affect the shell to be deformed during the process of molding.

Generally, there exists difference in heat consumption and accumulated heat stress between a surface layer and an insulation layer. The difference can cause de-lamination or separation between the heating layer and the insulation layer. Therefore, it appears desirable to use a method to avoid the separation by combining the functions of the above two layers in a non-separated single material and thus the inventors of the present invention herewith present the preferred embodiments of this method as shown below.

The mold according to the present invention is designed to comprise a shell 8 which has a thickness of about 6 mm, wherein the surface that forms the mold cavity constitutes a surface layer 16 while an insulation layer 17 is formed on its reverse side by mechanical process or electric discharge machining process of micro channels of having a thickness of 0.6-0.8 mm.

The above insulation layer 17 contains empty space of 20-90% of the layer based on cross-sectional area, and preferably 65-70%. The thickness of a surface layer is related to the amount of thermal energy required for molding. For example, micro-channels 15 are machined horizontally or vertically on the surface of the reverse side of the shell 8 so that there is a marginal thickness of 1 mm left in the surface layer. Micro-holes 18 can be drilled instead of micro-channels 15. The above structure of micro-channels 15 can be formed successively on the reverse side of the surface of the shell 8 horizontally or vertically. Each micro-channel 15 is connected to each other or connected to a cooling line 14 or 20 in the main body of the mold 4, respectively. Thus machined shell 8 is inserted into the shell receiver 10, and the borderline 13 between the shell 8 and the main body 4 of the mold become coalesced on the parting surface 6 of the main body of the mold. Alternatively, the surface of the reverse side of the shell 8 and the surface of the shell receiver 10 can be coalesced, if deemed necessary.

Examples of the materials for the shell include magnetic resonance materials such as iron, nickel, cobalt, etc., which are capable of performing induction heating. Examples of materials for main body of a mold 4 are those with high heat conductivity and the above-mentioned materials for the shell can be also used. Main body of a mold 4 hardly generates heat although the material used for the shell 8 is the same as that for the main body of a mold 4. Because the amount of electric current induced is inversely proportional to the square of a distance at the time of induction heating.

Here, the thickness of the surface layer is closely related to the amount of the amount of heat energy. Therefore, the amount of thermal mass of surface layer is designed to possess the minimal amount of energy for molding, i.e., the minimal amount of heat energy required for improving the quality or functions of a molded product. And the thickness of the surface layer is designed according to the material of the shell, a predetermined temperature, and the degree of insulation. Therefore, when much heat energy is required the surface layer is designed relatively thick.

Considering the above, a preferred embodiment of the present invention is to provide a shell 8 of low thermal mass having a thickness of 1-25 mm, a surface layer with a thickness of 0.3-5.0 mm, and an insulation layer to be determined to account for empty space of 20-90%.

Further, in case when the separation of a surface layer is not likely to happen because the surface layer is thick enough, for example, 0.5 mm or above, it is also possible to prepare the surface layer and the insulation layer not to be combined in an integrated form but micro-channels are machined on the main body of a mold 3 and inserted to be coalesced for the purpose of easier mold processing and assembly.

Meanwhile, if there is any part on the surface of mold cavity where temperature shall not be increased, the particular part of the shell can be made of a non-magnetic material. Then, electric current will not be induced in the specific part and thus temperature increase will be avoided accordingly.

The cooling method used in the present invention is as follows. In a system where a cooling fluid is circulated alternatively after circulating a heating fluid during a molding cycle, the required apparatus is quite complex and also the time required for a molding cycle becomes longer. Therefore, the present invention adopted a method to continuous cooling the main body of a mold 4 during molding cycle. For this purpose, the inventors of the present invention performed the cooling process by installing a cooling line 14 in the main body of mold 4, circulating a cooling fluid through the cooling line or connecting not only the main body 4 of a mold but also micro-channels 15 of an insulation layer 17 to a cooling line 20 or 14 of the main body 4 of a mold and allowing a cooling fluid flowing the micro-channels 15 thereby more actively performing the cooling process.

Alternatively, a cooling fluid inside the cooling line 20 and micro-channels 15 can be removed by means of compressed air or vacuum prior to heating in order to increase the efficiency of heating.

By this procedure, the present invention enables to improve the molding productivity by reducing the time for a molding cycle as well as improving the quality and functions of molded products.

In the present invention, induction heating of 50-400° C. is performed on the surface of mold cavity, i.e., on a surface layer 16 of the shell 8, for 0.5-20 sec, then the mold is closed after induction heating coil 23 is taken out and a molding material is cast into the mold wherein the heat energy of a surface layer 16 can improve the quality or functions of molded products as there is a contact between the surface of the mold and the molding material. Then, the temperature is cooled down to a desired temperature through a cooling process within 0.1-20 sec for inducing rapid cooling and solidification of a molded product and finally a molded product is taken out of the mold after opening the mold. At this stage of cooling, the time required for a molding cycle can be further reduced by forcing the cooling process of low thermal mass.

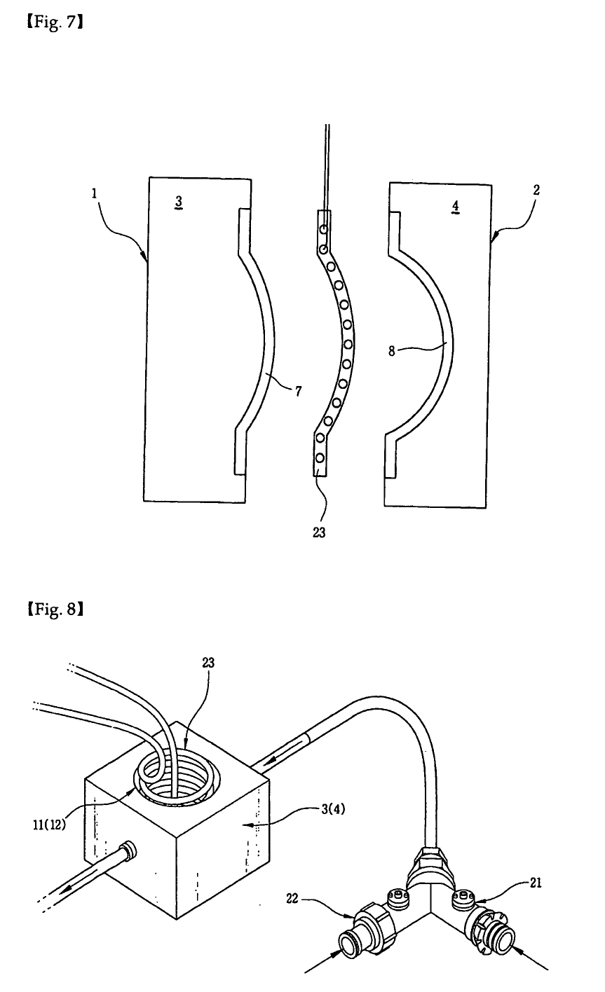

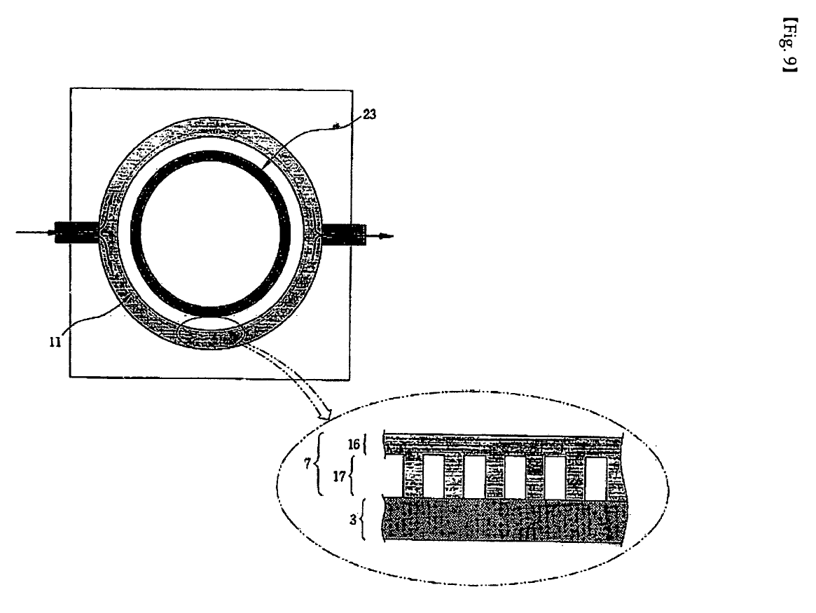

In a preferred embodiment of the present invention, the entire apparatus, as shown in FIG. 8, comprises a mold having a cylindrical cavity, an induction heating coil 23 to heat the surface of the cavity, a coolant line 21 for cooling, an compressed air line 22 to remove the coolant during heating process and the like.

FIG. 9 shows a diagrammatic view of a mold according to the present invention.

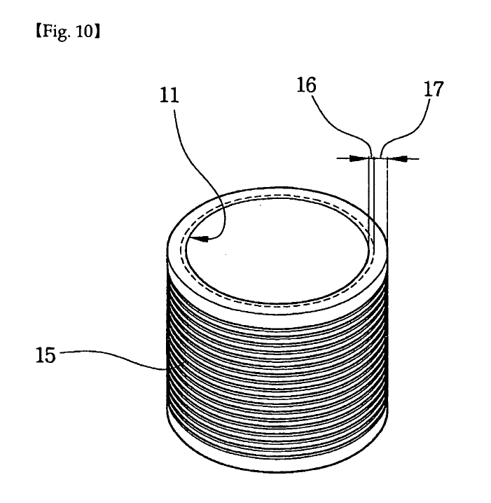

FIG. 10 shows a shell 8 of the surface of cavity wherein a surface layer 16 and an insulation layer 17 is combined as an integrated body.

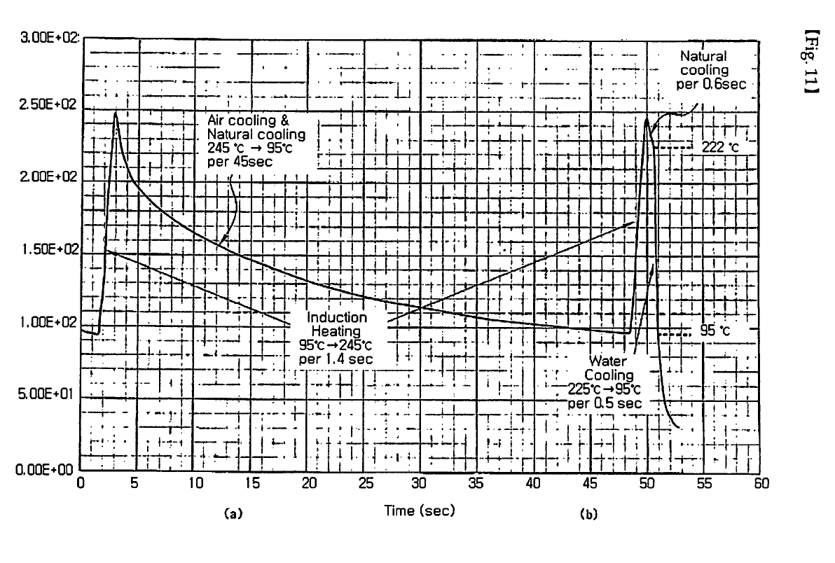

FIGS. 11a and 11b respectively shows a graph which reflects the change of temperature on the surface of mold cavity according to time passage in the course of heating and cooling according to the present invention. Here, the molding material used is the general carbon steel. The electric power used for induction heating was 18 kw, while the frequency was 15.3 kHz and the temperature of a coolant was 15° C. The temperature of cavity surface was increased from 95° C. to 245° C. by heating for 1.4 sec. FIG. 11a shows a case of natural cooling without using any particular coolant into the micro-channels 15 of the insulation layer 17 and it took 45 sec to be cooled down to 95° C., whereas FIG. 11b shows a case wherein a natural cooling was performed for 0.6 sec followed by a forced cooling by using a coolant through micro-channels and the result shows that it took 0.5 sec to be cooled down to 95° C.

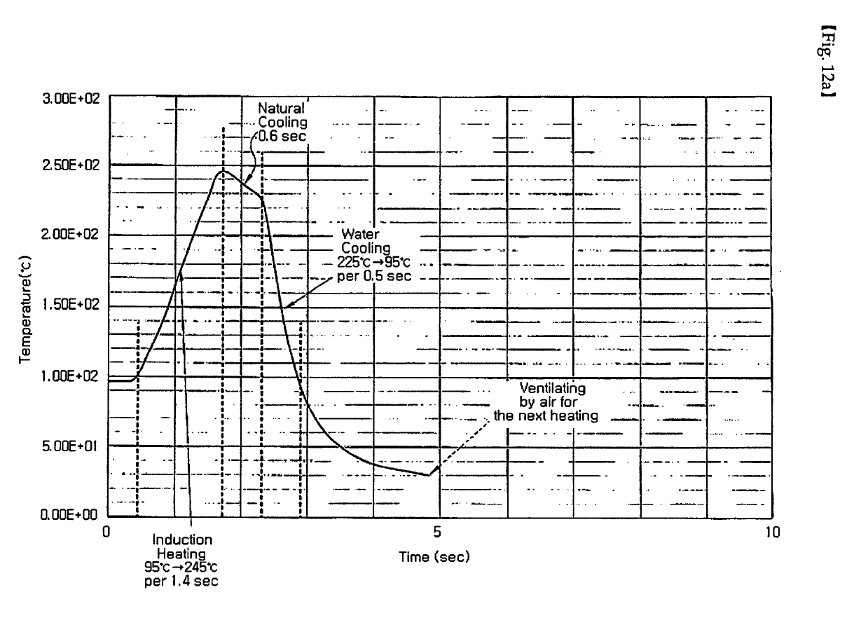

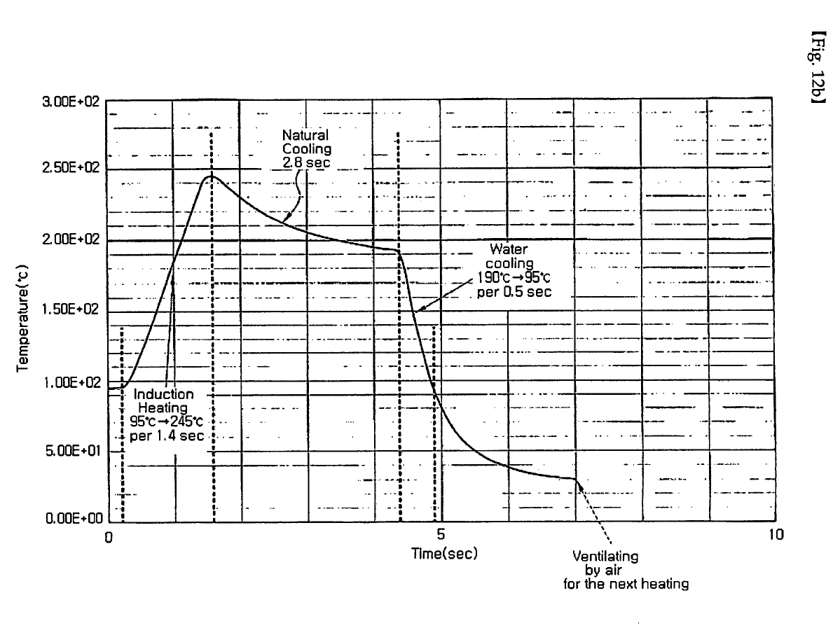

FIGS. 12a and 12b are enlarged graphs of FIG. 11b intended to provide a better view. FIG. 12a reflects the same case as in FIG. 11b while FIG. 12b reflects a case wherein the natural cooling time is extended to 2.8 sec followed by a forced cooling. The duration or temperature of a natural cooling is determined according to the amount of heat energy required for maximizing quality and functions of a molded product. Further, the operational conditions vary depending on the measures of the heating layer and the insulation layer and the properties of molding materials. While reheated, the coolant flowed into the insulation layer for cooling purpose in a previous cycle can be removed by means of compressed air or vacuum to increase heating efficiency.

The molding method and the mold used therein according to the present invention can be also used in an injection molding, a blow molding, a thermoforming and the like.

Examples of a blow molding are as follows.

The present invention can be applied to the heat setting process of PET bottles, which is designed to improve heat stability, to mold PET bottles with high heat stability as well as within a short molding cycle.

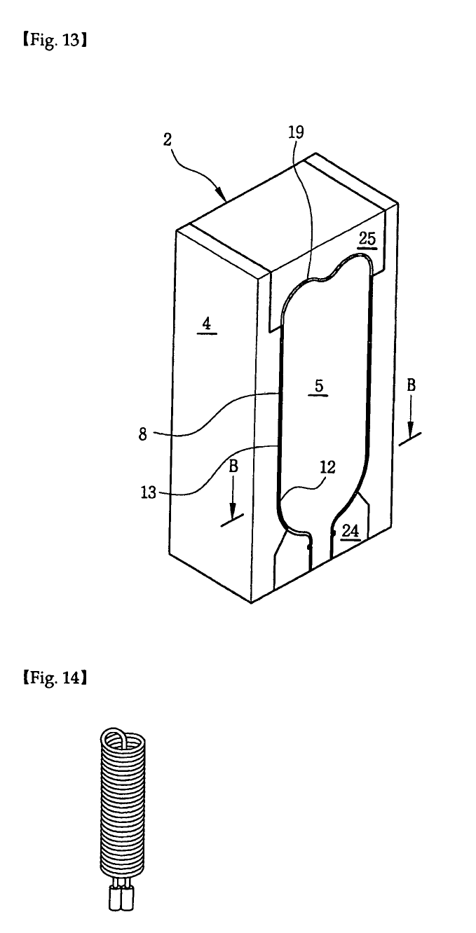

U.S. Pat. No. 4,476,170 discloses that heat setting at 200-250° C. can lead to production of PET bottles having heat stability high temperature of 100° C. or above. However, in U.S. Pat. No. 4,476,170, the heating and cooling process is conducted the circulation of heating and cooling fluid and this results in relatively long time of a molding cycle thus deteriorating commercial value. The present invention can be also applied to the invention to produce PET bottles with excellent heat stability and excellent productivity. An example is shown in FIG. 13.

The body part of the surface layer of the mold can be rapidly heated to 250° C. and rapidly cooled down by using a shell 8 of the present invention while a low temperature can be maintained for the neck portion 24 and the bottom portion 25 by composing them of a low magnetic resonance material or by properly designing the thickness of the heating layer and the insulation layer different from the dimension of the body portion of the bottle.

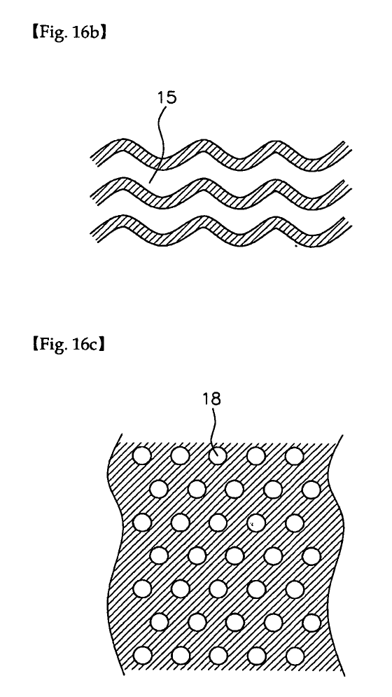

An induction heating coil can be manufactured as a cylindrical type as shown in FIG. 14. A detailed composition of the shell 8 and a cooling line is shown in FIGS. 15 and 16a-16c. The directionality of micro-channels of the shell 8 in FIG. 15 can be made as a longitudinal direction or a circumferential direction of the bottle as shown in the left and right of the FIG. 15.

As mentioned above, the present invention uses a shell, wherein a surface layer of low thermal mass and an insulation layer on the surface of its reverse side are combined as an integrated body, as the surface of mold cavity; uses a high temperature liquid circulation method or a high temperature object contact method to rapidly increase the temperature of the surface of the mold cavity or more specifically uses an induction heating method, which allows to be able to obtain uniform temperature distribution regardless of the shape of a product, temperature control via an insulation layer and a forced cooling method thus rapidly increasing or cooling down the temperature within a relatively short period of time and a uniform distribution of temperature; and also provides a method to resolve the de-lamination or separation problem, thereby improving the quality and functions of molded products while minimizing the cycle time of molding and also improving the overall molding productivity related to molding products.

Further, the present invention provides a way to actively increase temperature to a very high level with almost no limitation for the purpose of improving the quality and functions of products, to control by designing the surface layer and the insulation layer to be suitable for heat energy for molding, to improve productivity via an active cooling process, to improve durability by having an integrated body with both the surface layer and the insulation layer in one material, and to provide excellent applicability by allowing mechanical machining or electric discharge machining process.

What is claimed is:

1. A method for molding a product which comprises the steps of heating of surface layer of mold cavity, filling of molding materials into the mold cavity, and cooling,
wherein the mold comprises a cavity, an integrated shell comprising a surface layer and an insulation layer in which micro-channels or micro-holes are constructed, and a main body of said molds;
the surface layer of said mold cavity is passively or aggressively heated via induction heating to the temperature of 50-400° C. for 0.5-20 sec; and
the surface layer of said mold cavity is cooled down within 0.1-20 sec after casting a molding material to said mold by circulating a cooling fluid through a cooling line in the main body of said mold and or circulating a cooling fluid through micro-channels in said insulation layer on the reverse side underneath said surface layer.

2. The method for molding a product according to claim 1, wherein a part of said shell is substituted with a low magnetic-resonance material when there is a need to avoid temperature increase in a part of the surface of said mold cavity.

3. The method for molding a product according to claim 1, wherein a cooling fluid is continuously circulated through the cooling line installed in the main body of said mold during both said heating and said cooling step.

4. The method for molding a product according to claim 1, wherein a cooling fluid is circulated through said micro-channels during said cooling step.

5. The method for molding a product according to any of claims 1 and 4, wherein, during said heating step, said heating is conducted after completely stopping the circulation of a cooling fluid through said micro-channels in the insulation layer and removing said cooling fluid from said micro-channels by means of compressed air or vacuum, and the circulation of a cooling fluid is conducted in due course during the step of cooling thereafter.

6. A mold for molding a product comprising
a cavity,
an integrated shell comprising
a surface layer with a predetermined thickness which serves as the surface of said cavity; and
an insulation layer comprising micro-channels or micro-holes arrayed on the reverse side underneath said surface layer;
and a main body of said mold where said insulation layer is contacted.

7. The mold according to claim 6, wherein said shell consists of a material which can be well heated by induction heating.

8. The mold according to claim 6, wherein said shell, being contacted into said main body, is coalesced only in a border line on a parting surface between left side and right side of said mold.

9. The mold according to any one of claims 6 to 8, wherein said shell is 1-25 mm thick and said heating layer is 0.3-10.0 mm thick.

10. The mold according to claim 6, wherein said insulation layer contains micro-channels or micro-holes of which area portion is 20-90% of the surface layer.

11. The mold according to claim 6, wherein said micro-channels are formed in a linear or a wave pattern in said insulation layer.

12. The mold according to any of claims 6, 7, 8, 10 and 11, wherein said micro-channels are 0.3-10.0 mm wide.

13. The mold for molding a product according to claim 6, wherein said micro-hole is 0.3-10.0 mm in diameter.

14. The mold according to claim 6, wherein a part of said shell comprising a heating layer and an insulation layer can be substituted with a low magnetic resonance material when there is a need to avoid temperature increase in a part of the surface of the cavity of said mold.

15. The mold according to claim 6, wherein a cooling line is installed in the main body of said mold in order to continuously circulate a cooling fluid through the cooling line during both heating and cooling period.

16. The mold according to claim 6, wherein besides said cooling line for the main body of said mold, a separated cooling line is directly connected to micro-channels of said insulation layer for the circulation of cooling fluid like cold water through said micro-channels during cooling period.

17. A product manufactured by the method for molding according to claim 1.
